(19) United States
(12) Patent Application Publication
(10) Pub. No.: US 2024/0227356 A9
(43) Pub. Date: Jul. 11, 2024

(54) FLUORINATED-RUBBER-METAL LAMINATE

(71) Applicant: NOK CORPORATION, Tokyo (JP)

(72) Inventors: Masahiro YOKOO, Fukushima (JP); Nobuaki TANAKA, Fukushima (JP)

(21) Appl. No.: 18/277,690

(22) PCT Filed: Feb. 17, 2022
(86) PCT No.: PCT/JP2022/006431

§ 371 Date: Aug. 17, 2023

(30) Foreign Application Priority Data
Feb. 22, 2021 (JP) 2021-026409

(51) Int. Cl. B32B 15/06; B32B 7/12; B32B 15/18; B32B 25/14; C09D 183/04; F16J 15/12

(52) U.S. Cl. CPC B32B 15/06; B32B 7/12; B32B 15/18; B32B 25/14; C09D 183/04; F16J 15/12; B32B 2255/10; B32B 2255/26; B32B 2581/00

(57) ABSTRACT

A rubber-metal laminate includes: a metal sheet; a fluorinated rubber layer laminated on one surface or both surfaces of the metal sheet; and a surface-coating layer with which the fluorinated rubber layer is coated, wherein the surface-coating layer is a cured film obtained by curing of a coating film of a surface-coating agent containing a silicone emulsion, and the silicone emulsion is contained at 10 mass % or more in the surface-coating agent.

### CROSS REFERENCE TO RELATED APPLICATIONS

This is the National Stage of International Application No. PCT/JP2022/006431, filed Feb. 17, 2022, which claims the benefit of Japanese Patent Application No. 2021-026409, filed Feb. 22, 2021. The contents of these applications are incorporated hereby by reference in their entirety.

### BACKGROUND

### Technical Field

The present disclosure relates to a fluorinated-rubber-metal laminate.

### Related Art

A metal gasket that is sandwiched between two members, such as a cylinder head and cylinder block in an internal combustion engine, for sealing has been conventionally proposed. For example, Japanese Patent Application Publication No. 2003-130224 discloses a metal gasket including a rubber-metal laminate including a metal substrate and a rubber layer provided on both main surfaces of the metal substrate. The metal gasket seals a gap between the cylinder head and the cylinder block, which are sealing target members, with fastening of the rubber-metal laminate between the cylinder head and the cylinder block.

In the rubber-coating metal for a gasket in which both main surfaces of a metal substrate are coated with a rubber layer (rubber-metal laminate), the rubber layer is commonly formed from a fluorinated rubber material. Having excellent heat resistance, the fluorinated rubber material can be used under a high-temperature environment where a nitrile-rubber material cannot be used in many cases. However, the use under a high-temperature environment for a long time generates hydrofluoric acid, and forms an active double bond with rich reactivity in the fluorinated rubber.

In such a case, the generated hydrofluoric acid can be trapped by blending an acid acceptor in a fluorinated rubber composition that is to form the rubber layer, but on the other hand, the active double bond still remains in the fluorinated rubber. Since the fluorinated rubber material is typically used as a sealing material for a cylinder head gasket, and the like, operation is made in a sandwiched state by housing materials. Thus, in the fluorinated rubber material, the active double bond causes a bonding reaction between the fluorinated rubber material and the housing material, and an extremely strong bond is formed with the housing material.

As a measure for preventing the bonding to the housing material, a method in which a thin film is formed on a surface of the fluorinated rubber layer by using a surface-coating agent to prevent the bonding reaction occurring on an interface between the fluorinated rubber layer and the housing material is effective. In this case, the requirements are: that the thin film has strength durable under the use environment; that the thin film itself does not react with (bond to) the housing material; and the like. For example, in Japanese Patent Application Publication No. 2008-189892, as a surface-treating agent for vulcanized rubber that satisfies performance required for a coating agent for rubber-like elastomer and the like, such as prevention of bonding, prevention of adhesion, prevention of blocking, and improvement in wearing resistance, and that does not cause peeling of the coating film due to adhesion during high-temperature compression and frictional wearing at a high surface pressure, a coating agent containing (a) a cellulose derivative, (b) an isocyanate-group-containing 1,2-polybutadiene, and (c) at least one of a wax having a softening point of 40 to 160° C., graphite, and fluorinated resin is disclosed.

In Japanese Patent Application Publication No. 2008-189892, it is disclosed that, when this coating agent is applied for a nitrile-rubber-metal laminate, in a high-temperature adhesion test with an aluminum sheet under a condition of 200° C., 72 hours, and 19.6 MPa, an adhesion force on the surface is almost zero, or as small as approximately 1 MPa even when the adhesion force is observed. However, evaluation of an adhesion test in a case of application for the fluorinated-rubber-metal laminate is not mentioned.

In Japanese Patent Application Publication No. 2013-189600, evaluation results when the above coating agent is applied for the fluorinated-rubber-metal laminate are described as Comparative Example, but the bonding force with an aluminum sheet under a condition of 200° C., 500 hours, and 200 MPa exhibits a high value of 10 MPa. Thus, at present, even when a thin film is formed on a fluorinated rubber layer by using a surface-coating agent, breaking of the thin film occurs after a durability test, and the bonding to the housing is observed. Considering such circumstances, development of novel technology that does not cause breakage of the thin film even under the use environment and that can inhibit the bonding between the fluorinated-rubber-metal laminate and the housing material is desired.

### SUMMARY

### Technical Problem

An object of the present disclosure is to provide a fluorinated-rubber-metal laminate that can inhibit the bonding to the housing material under the use environment.

### Solution to Problem

A fluorinated-rubber-metal laminate according to the present embodiment includes: a metal sheet; a fluorinated rubber layer laminated on one surface or both surfaces of the metal sheet; and a surface-coating layer with which the fluorinated rubber layer is coated, wherein the surface-coating layer is a cured film obtained by curing of a coating film of a surface-coating agent containing a silicone emulsion, and the silicone emulsion is contained at 10 mass % or more in the surface-coating agent.

In an embodiment of the present disclosure, at least 20 mg/m² of bloom is precipitated on a surface of the surface-coating layer.

In an embodiment of the present disclosure, the silicone emulsion is selected from the group consisting of an amino-modified-type silicone emulsion, an epoxy-modified-type silicone emulsion, a dimethyl-type silicone emulsion, a reactive-type silicone emulsion, a silicone emulsion for an inorganic fiber, an anionic siloxane-crosslinking-type acryl emulsion, and a cationic siloxane-crosslinking-type acryl emulsion.

In an embodiment of the present disclosure, the metal sheet is a steel sheet.

In an embodiment of the present disclosure, a thickness of the surface-coating layer is 0.5 μm or more.

In an embodiment of the present disclosure, an adhesive is interposed between the metal sheet and the fluorinated rubber layer.

In an embodiment of the present disclosure, the fluorinated-rubber-metal laminate is a material for a gasket.

### Effects of Disclosure

According to the present disclosure, the fluorinated-rubber-metal laminate that can inhibit the bonding to the housing material under the use environment can be achieved.

### BRIEF DESCRIPTION OF THE DRAWINGS

FIG. 1 is an outline schematic diagram illustrating a mechanism for inhibiting bonding to a housing material by the fluorinated-rubber-metal laminate according to the present disclosure.

FIG. 2 is a schematic diagram illustrating an outline of a test for evaluating bonding between a fluorinated-rubber-metal laminate produced in Example and the housing material.

### DETAILED DESCRIPTION

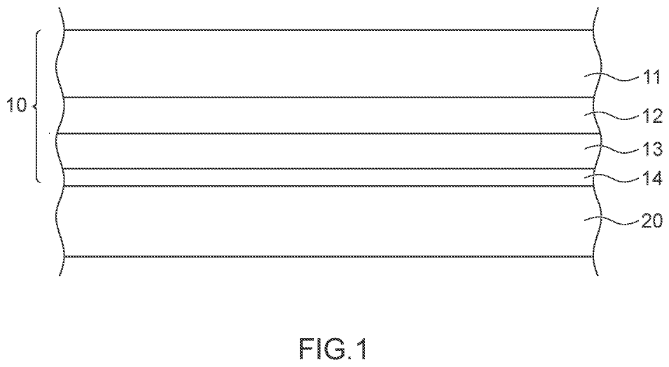

Hereinafter, embodiments of the present disclosure will be described in detail. The fluorinated-rubber-metal laminate according to the present embodiment is suitably used as a material for a gasket such as a gasket for a cylinder head and a gasket for a compressor. FIG. 1 schematically illustrates an example of a layered structure of the fluorinated-rubber-metal laminate according to the present embodiment. As illustrated in FIG. 1, a fluorinated-rubber-metal laminate 10 includes: a metal sheet 11; a fluorinated rubber layer 12 laminated on the metal sheet 11; and a surface-coating layer 13 with which the fluorinated rubber layer 12 is coated. The surface-coating layer 13 is a cured film obtained by curing of a coating film of a surface-coating agent containing a silicone emulsion, and the silicone emulsion is contained at 10 mass % or more in the surface-coating agent. In the present embodiment, the surface-coating agent containing the predetermined amount of the silicone emulsion is used when the surface-coating layer 13 is formed, and a certain amount of a bloom component is added in the surface-coating agent. According to a bloom 14 generated from a thin film formed by using such a surface-coating agent, the fluorinated rubber layer 12 is protected together with the surface-coating layer 13. According to this, the fluorinated rubber layer 12 and a housing material 20 are separated, which can inhibit bonding to the housing material 20. In addition, since the silicone component in the thin film reacts with an active double bond remained on a surface of the fluorinated rubber layer 12 to deactivate the double bond, bonding points to the housing material 20 can be reduced. Hereinafter, each component of the fluorinated-rubber-metal laminate according to the present embodiment will be described in detail.

<Metal Sheet>

As the metal sheet, steel sheets of iron, stainless steel, and the like are used, for example. As the steel sheet of iron, a cold rolled steel sheet (SPCC: Steel Plate Cold Commercial), a high-tensile steel sheet, a soft steel sheet, and the like are used, for example. As the steel sheet of stainless steel, ferrite-type, martensite-type, or austenite-type stainless steel sheet, and the like can be used, for example. As specific examples of stainless steel, SUS304, SUS301, SUS301H, SUS430, and the like can be mentioned, for example.

It is preferable that the metal sheet be used in a state where the metal surface is defatted with an alkali defatting treatment or the like. The metal sheet is used with the metal surface roughened by shot blasting, Scotch-Brite®, hairline, dull-finish and the like, if necessary.

In the metal sheet, it is preferable that an adhesion surface with the fluorinated rubber layer or an adhesive, which is optionally interposed, be subjected to a substrate treatment (surface treatment). The substrate treatment is not particularly limited, and known substrate treatments can be used. As a specific example of the substrate treatment when an iron material and a stainless material such as the cold rolled steel sheet and a stainless steel sheet are used as the metal sheet, a chemical treatment method using various chemical treating agents is preferable. As the chemical treatment for the metal sheet such as the cold rolled steel sheet, for example, a phosphate treatment such as a zinc-phosphate treatment and an iron-phosphate treatment can be mentioned. As the chemical treatment for the metal sheet such as a stainless steel sheet, for example, a chemical treatment for forming an inorganic coating film of a compound of a metal such as vanadium, zirconium, titanium, molybdenum, tungsten, manganese, zinc, and cerium, specifically a metal oxide of these metals and the like, a chemical treatment for forming a composite coating film of an organic coating film such as a silane, a phenolic resin, an epoxy resin, and a polyurethane, and an inorganic coating film, and the like can be mentioned. With any chemical treatments, a chromium-free chemical treatment containing substantially no chromium is preferable from the viewpoint of environmental protection.

The substrate treatment of the metal sheet with the chemical treatment is performed by contacting the chemical treating agent with the metal sheet with known liquid-contacting methods such as atomizing, spraying, immersing, brush coating, and a roll coater. In a case of a reactive chemical treating agent, it is needed that a time and temperature required for the reaction are prepared.

A thickness of the metal sheet is appropriately set according to use of the fluorinated-rubber-metal laminate. When the fluorinated-rubber-metal laminate is used for a sealing material such as a gasket, it is preferable that the thickness of the metal sheet be 100 μm or more and 2000 μm or less, it is more preferable that it be 200 μm or more and 1000 μm or less, and it is further preferable that it be 300 μm or more and 500 μm or less, for example.

In the fluorinated-rubber-metal laminate, it is preferable that a primer layer be formed on the metal sheet in addition to the substrate treatment or instead of the substrate treatment. By performing the substrate treatment or forming the primer layer, adhesiveness between the fluorinated rubber layer and the metal sheet in the fluorinated-rubber-metal laminate is improved, and heat resistance and water resistance of the fluorinated-rubber-metal laminate can be remarkably improved. In addition, by performing the substrate treatment or forming the primer layer, the fluorinated-rubber-metal laminate can be preferably used as a gasket that is a laminated composite metal in which the fluorinated-rubber-metal laminate is laminated with another metal sheet and the like.

The primer layer can be formed by using: compounds of metals such as titanium, zirconium, vanadium, aluminum, molybdenum, tungsten, manganese, zinc, and cerium, and inorganic compounds such as an oxide thereof; organic compounds such as a silicone resin, a phenolic resin, an epoxy resin, and a polyurethane; or the like. The primer layer may be formed by using commonly commercially available primer solutions, or can be formed by using other primer solutions of various known art.

The primer layer is formed by a primer solution in which a raw material containing the above various inorganic compounds or organic compounds is dissolved or dispersed in an organic solvent or an aqueous solvent. As a usable organic solvent, alcohols such as methanol, ethanol, and isopropyl alcohol, ketones such as acetone and methyl ethyl ketone, and the like can be mentioned, for example. The primer solution may be prepared as an aqueous solution using an aqueous solvent as long as it maintains the liquid stability.

The obtained primer solution is applied onto the metal sheet by using a spray, immersion, a brush, a roll coater, and the like. Then, the primer layer is provided by drying the primer solution applied onto the metal sheet at room temperature or with warm blowing, or by baking treatment.

<Adhesive>

The adhesive bonds the fluorinated rubber layer and the metal sheet. As the adhesive, commonly commercially available adhesives such as a phenolic resin, an epoxy resin, a polyurethane, and a silane are used. These adhesives can be appropriately selected according to use of the fluorinated-rubber-metal laminate.

In the fluorinated-rubber-metal laminate, it is preferable that the metal sheet and the rubber layer be bonded with a phenolic resin used as one component of a vulcanized adhesive interposed therebetween. According to this, the adhesiveness between the metal sheet and the fluorinated rubber layer is improved in the fluorinated-rubber-metal laminate.

As the phenolic resin, a novolac-type phenolic resin and a resol-type phenolic resin are used, for example. The novolac-type phenolic resin and the resol-type phenolic resin may be used singly, or may be used in combination of two or more thereof. As the adhesive, two phenolic resins of the novolac-type phenolic resin and the resol-type phenolic resin may be used as main components, and an appropriate amount of an unvulcanized fluorinated rubber or a compound thereof may be added to use.

As the novolac-type phenolic resin, one in which phenols and formaldehyde are subjected to a condensation reaction in the presence of an acid catalyst is used. As the phenols, ones having two or three substitutable hydrogen atoms at at least one of o-position and p-position with respect to a phenolic hydroxy group of, for example, phenol, p-cresol, m-cresol, p-tert-butylphenol, p-phenylphenol, and bisphenol A are used. These phenolic resins may be used singly, or may be used in combination of two or more thereof. As the acid catalyst, oxalic acid, hydrochloric acid, maleic acid, and the like are used, for example. Among them, it is preferable that the novolac-type phenolic resin have a softening point of 80° C. or higher and 150° C. or lower, and it is more preferable that the novolac-type phenol resin be manufactured by using a mixture of m-cresol and p-cresol and formaldehyde, and have a softening point of 100° C. or higher from the viewpoint of improvement in the adhesiveness between the metal sheet and the fluorinated rubber layer.

As the resol-type phenolic resin, one in which phenols and formaldehyde are subjected to a condensation reaction in the presence of a base catalyst is used. As the phenols, ones having two or three substitutable hydrogen atoms at at least one of o-position and p-position with respect to a phenolic hydroxy group of, for example, phenol, p-cresol, m-cresol, p-tert-butylphenol, p-phenylphenol, and bisphenol A are used. These phenolic resins may be used singly, or may be used in combination of two or more thereof. As the base catalyst, sodium hydroxide, sodium carbonate, magnesium hydroxide, ammonia, and the like are used, for example.

The aforementioned each adhesive is used as a solution in which it is dissolved in an organic solvent. As the organic solvent, alcohols such as methanol, ethanol, and isopropyl alcohol, ketones such as methyl ethyl ketone and methyl isobutyl ketone, and a mixed solvent thereof are typically used. These organic solvents may be use singly, or may be used in combination of two or more thereof.

It is preferable that the adhesive be blended at a proportion of, for example, 10 parts by mass or more and 1000 parts by mass or less of the resol-type phenolic resin per 100 parts by mass of the novolac-type phenolic resin, and it is more preferable that it be blended at a proportion of 60 parts by mass or more and 400 parts by mass or less. By setting the adhesive at 1000 parts by mass or less of the resol-type phenolic resin per 100 parts by mass of the novolac-type phenolic resin, deterioration of the adhesiveness of the fluorinated rubber layer can be prevented. In addition, by setting the proportion to 10 parts by mass or more, deterioration of the adhesiveness to the surface of the metal sheet can be prevented.

It is preferable that the adhesive be applied on the metal sheet on which the primer layer is formed from the viewpoint of improvement in the adhesiveness between the metal sheet and the fluorinated rubber layer. The adhesive layer may be formed as a single layer, or may be formed as a multilayer. The adhesive layer may be provided as a multistage structure by forming a phenolic adhesive layer including an organometal compound on the primer layer provided on the metal sheet, and then, on the adhesive layer, forming an additional phenolic adhesive layer. By forming such an adhesive layer of the multistage structure, the adhesiveness between the primer layer and the fluorinated rubber layer can be further strengthened.

The adhesive is prepared as an applying liquid at a solid-content concentration of 0.1 mass % or more and 10 mass % or less by using the aforementioned organic solvent and a mixed solvent thereof. The applying liquid of the adhesive is applied onto the metal sheet, and then subjected to drying and baking treatment under a condition at 100° C. or higher and 250° C. or lower for 1 minute or longer and approximately 30 minutes to be formed into the adhesive layer. It is preferable that the amount of the adhesive applied be such that the coating mass after drying and baking treatment following application is within a range of 50 mg/m² or more and 2000 mg/m² or less. It is preferable that the adhesive be applied so that the thickness of the adhesive layer after the drying is 0.5 μm or more and 5 μm or less.

<Fluorinated Rubber Layer>

In the rubber-metal laminate according to the present embodiment, the fluorinated rubber layer is formed by using a fluorinated rubber. Specifically, an unvulcanized fluorinated rubber compound is applied as an organic solvent solution so that a vulcanized product layer with 5 to 120 μm in thickness on one side is formed on one surface or both surfaces of the metal sheet. The applied unvulcanized rubber layer is dried at a temperature from a room temperature to approximately 100° C. for approximately 1 to 15 minutes, and then alcohols such as methanol, ethanol, and isopropyl alcohol, ketones such as methyl ethyl ketone and methyl isobutyl ketone, aromatic hydrocarbons such as toluene and xylene, or a mixed solvent thereof that are used as the organic solvent is evaporated, then vulcanized with heating at approximately 150 to 230° C. for approximately 0.5 to 30 minutes, and if necessary, vulcanized with pressurizing. It is preferable that the vulcanized fluorinated rubber layer have a hardness (durometer A) of 80 or more and a compression set (100° C., 22 hours) of 50% or less in terms of the use as a gasket.

As the fluorinated rubber, any type of fluorinated rubbers of a polyol-crosslinking fluorinated rubber, a peroxide-crosslinking fluorinated rubber, and an amine-crosslinking fluorinated rubber can be used, and not particularly limited. As the unvulcanized rubber compound, a blending example disclosed in Japanese Patent Application Publication No. 2006-218629 can be mentioned, for example.

As the polyol-crosslinking fluorinated rubber, a copolymer of vinylidene fluoride and another fluorine-containing olefin, for example, at least one of hexafluoropropene, pentafluoropropene, tetrafluoroethylene, trifluorochloroethylene, vinyl fluoride, perfluoro(methyl vinyl ether), and the like, a copolymer of a fluorine-containing olefin and propylene, and the like can be mentioned, for example. These fluorinated rubbers are polyol-crosslinked by a polyhydroxy aromatic compound such as 2,2-bis(4-hydroxyphenyl)propane, 2,2-bis(4-hydroxyphenyl)perfluoropropane, and hydroquinone as a crosslinker.

As the peroxide-crosslinking fluorinated rubber, a fluorinated rubber having iodine and/or bromine in the molecule can be mentioned, for example. These fluorinated rubbers are typically crosslinked by an organic peroxide as a crosslinker. When crosslinking using the organic peroxide, it is preferable that a polyfunctional unsaturated compound represented by triallylisocyanurate be used as a crosslinking accelerator in combination with the organic peroxide.

As the amine-crosslinking fluorinated rubber, an amine crosslinker such as 4,4′-methylenebis(cyclohexylamine) carbamate, hexamethylenediamine carbamate, and N,N′-dicinnamylidene-1,6-hexanediamine is used, for example.

A thickness of the rubber layer is not particularly limited, but it is preferable that it be 200 μm or less, it is more preferable that it be 90 μm or more and 150 μm or less, and it is further preferable that it be 100 μm or more and 140 m or less.

<Surface-Coating Layer>

On one surface or both surfaces of the formed fluorinated rubber layer, a surface-coating layer is applied. The surface-coating layer is a cured film obtained by curing of a coating film of a surface-coating agent containing a silicone emulsion, and the silicone emulsion is contained at 10 mass % or more, preferably 20 mass % or more, in the surface-coating agent. By the silicone emulsion contained at 10 mass % or more in the surface-coating agent, bloom is precipitated on a surface of the surface-coating layer. An amount of the bloom precipitated is proportional to the content of the silicone emulsion contained in the surface-coating agent. Specifically, it is preferable that at least 20 mg/m² of the bloom be precipitated on the surface of the surface-coating layer, and it is preferable that 40 mg/m² or more of the bloom be precipitated. The bloom that precipitates on the surface of the surface-coating layer protects the fluorinated rubber layer together with the surface-coating layer, and the fluorinated rubber layer and the housing material are separated, and thereby the bonding to the housing material can be inhibited.

The silicone emulsion is one in which an emulsifier and the like are added into water, an alcohol, or a mixed liquid thereof to be uniformly dispersed, and applied on the fluorinated rubber layer and then dried to form a thin film. The silicone emulsion is not particularly limited, but it is preferable that it be selected from the group consisting of an amino-modified-type silicone emulsion, an epoxy-modified-type silicone emulsion, a dimethyl-type silicone emulsion, a reactive-type silicone emulsion, a silicone emulsion for an inorganic fiber, an anionic siloxane-crosslinking-type acryl emulsion, and a cationic siloxane-crosslinking-type acryl emulsion, and it is more preferable that it be selected from an amino-modified-type silicone emulsion and an epoxy-modified-type silicone emulsion.

As a commercially available product of the silicone emulsion, POLON series manufactured by Shin-Etsu Chemical Co., Ltd., and ATW and CTW series manufactured by Taisei Fine Chemical Co., Ltd. can be mentioned, for example.

In the surface-coating agent containing the silicone emulsion, various additives may be appropriately contained, and it is contained at an addition amount of 1 mass % or more and 90 mass % or less in the surface-coating agent. As the additive, a water-soluble resin such as a cellulose resin and a melamine resin, an anionic, cationic, or nonionic surfactant (surface-adjusting agent), a pigment such as graphite and carbon black, water-dispersed synthesized wax, rebelling agent, and the like can be mentioned. For example, the water-soluble resin is added when the thickness of the surface-coating layer is increased, and the like, the pigment such as graphite and carbon black is added for an effect of matting the surface-coating layer, and the water-dispersed wax is added to impart slipperiness. Using such an additive can improve thin film strength and applicability of the surface-coating agent. Note that, these additives just impart a supplementary function to the surface-coating layer, and the silicone emulsion significantly affects the inhibition of bonding between the fluorinated rubber layer and the housing material.

The surface-coating agent is adjusted by using a roll mill and the like and by uniformly dispersing each component contained in the surface-coating agent, and applied on the surface of the fluorinated rubber layer on the metal sheet so that a thickness of the surface-coating layer after baking (after curing) is 0.5 μm or more. Thereafter, the drying and baking treatment is performed at 150 to 250° C. for 0.5 to 30 minutes, and a cured film obtained by curing the coating film of the surface-coating agent containing the silicone emulsion is formed on the fluorinated rubber layer. Note that, an upper limit value of the thickness of the surface-coating layer is not particularly limited, but it is preferable that it be 5.0 μm or less from the viewpoint of a thickness of the entire fluorinated-rubber-metal laminate (entire thickness).

<Method of Manufacturing Fluorinated-Rubber-Metal Laminate>

The fluorinated-rubber-metal laminate according to the present embodiment is manufactured by: applying the unvulcanized fluorinated rubber compound onto a metal sheet that has been subjected to the surface treatment if necessary, with the adhesive layer disposed therebetween; and then vulcanizing the fluorinated rubber compound under a condition, for example, at 160° C. or higher and 250° C. or lower for approximately 0.5 minutes or longer and 30 minutes or shorter to form the fluorinated rubber layer on the metal sheet. Thereafter, the surface-coating agent containing the silicone emulsion is applied onto the fluorinated rubber layer, and the obtained coating film is cured by the drying and baking treatment to form the surface-coating layer.

The embodiments of the present disclosure have been described above; however, the present disclosure is not limited to the above embodiments, includes any aspects included in the concept and claims of the present disclosure, and can be variously modified in the scope of the present disclosure.

### EXAMPLE

Hereinafter, Examples of the present disclosure will be described, but the present disclosure is not limited to these examples as long as not departing from the spirit.

### Example 1

On a polyol-crosslinking fluorinated rubber layer (thickness 25 m) formed on a SUS steel sheet, a surface-coating agent containing 100 mass % of a silicone emulsion A (trade name “POLON-MF-14E”, manufactured by Shin-Etsu Chemical Co., Ltd.) was uniformly dispersed with a roll mill, and the obtained dispersed liquid was applied onto the fluorinated rubber layer by a roll-applying method. Then, the obtained coating film was subjected to a drying and baking treatment at 200° C. for 10 minutes to produce a fluorinated-rubber-metal laminate in which a surface-coating layer was formed on the fluorinated rubber layer so that a thickness after the baking was 2.0 m.

<Evaluation of Bonding Test>

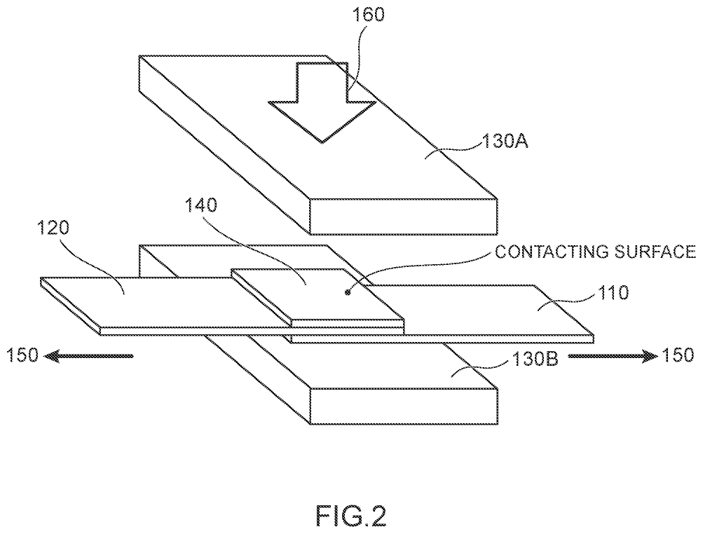

As illustrated in FIG. 2, both end portions with 25 mm of a fluorinated-rubber-metal laminate 110 (width 25 mm) on which the surface-coating agent was applied and SUS steel sheet 120 (width 25 mm and thickness 0.20 mm) as a housing material were oppositely contacted, a SUS steel plate (width 25 mm and thickness 0.20 mm) was provided as a patch 140 between the SUS steel sheet 120 and a tool 130A, and pressurizing was performed by tools 130A and 130B from a direction of an arrow 160 so that a maximum surface pressure was 250 MPa to perform a heat treatment at 200° C. for within a range of 24 to 1000 hours. After the heat treatment, the tools 130A and 130B were removed, and since the fluorinated-rubber-metal laminate 110 and the SUS steel sheet 120 were bonded, the fluorinated-rubber-metal laminate 110 and the SUS steel sheet 120 were drawn in a direction of an arrow 150 with an autograph to perform a tensile test. In the tensile test, a force at which the fluorinated-rubber-metal laminate 110 and the SUS steel sheet 120 were separated was evaluated as a bonding force. The results are shown in Table 1. Note that, one in which the fluorinated-rubber-metal laminate 110 and the SUS steel sheet 120 were not bonded when the tools 130A and 130B were removed was judged as to have a bonding force of “0 MPa”. Evaluation results at 200° C. and a time of 72 hours, which exhibited the maximum bonding force, are shown in Table 1. This is because an increase in the bonding force was not observed even with performing further heat treatment, and some materials failed to be precisely evaluated with an effect of rubber curing due to thermal aging.

### Example 2

A fluorinated-rubber laminated metal sheet was produced to perform the bonding test in the same manner as in Example 1 except that a silicone emulsion B (trade name “POLON-MN-ST”, manufactured by Shin-Etsu Chemical Co., Ltd.) was used instead of the silicone emulsion A. The results are shown in Table 1.

### Example 3

A fluorinated-rubber laminated metal sheet was produced to perform the bonding test in the same manner as in Example 1 except that a silicone emulsion C (trade name “?POLON-MF-18T”, manufactured by Shin-Etsu Chemical Co., Ltd.) was used instead of the silicone emulsion A. The results are shown in Table 1.

### Example 4

A fluorinated-rubber laminated metal sheet was produced to perform the bonding test in the same manner as in Example 1 except that a cellulose resin (trade name “METOLOSE® SM-100”, manufactured by Shin-Etsu Chemical Co., Ltd.) as a water-soluble resin and a nonionic surfactant (trade name “SURFLON S-386”, manufactured by AGC SEIMI CHEMICAL CO., LTD.) as a surfactant (surface-adjusting agent) were further added into the surface-coating agent to perform adjustment so that, in the surface-coating agent, the content of the silicone emulsion A was 90 mass %, a content of the water-soluble resin was 9 mass %, and a content of the surfactant was 1 mass %. The results are shown in Table 1.

### Example 5

A fluorinated-rubber laminated metal sheet was produced to perform the bonding test in the same manner as in Example 4 except that adjustment was performed so that, in the surface-coating agent, the content of the silicone emulsion A was 70 mass % and the content of the water-soluble resin was 29 mass %. The results are shown in Table 1.

### Example 6

A fluorinated-rubber laminated metal sheet was produced to perform the bonding test in the same manner as in Example 1 except that a cellulose resin (trade name “METOLOSE® SM-100”, manufactured by Shin-Etsu Chemical Co., Ltd.) as a water-soluble resin, graphite (trade name “AQ-E3571”, manufactured by RESINO COLOR INDUSTRY CO., LTD.), and a nonionic surfactant (trade name “SURFLON S-386”, manufactured by AGC SEIMI CHEMICAL CO., LTD.) as a surfactant (surface-adjusting agent) were further added into the surface-coating agent to perform adjustment so that, in the surface-coating agent, the content of the silicone emulsion A was 40 mass %, a content of the water-soluble resin was 47 mass %, a content of the graphite was 12 mass %, and a content of the surfactant was 1 mass %. The results are shown in Table 1.

### Example 7

A fluorinated-rubber laminated metal sheet was produced to perform the bonding test in the same manner as in Example 6 except that adjustment was performed so that, in the surface-coating agent, the content of the silicone emulsion A was 20 mass %, the content of the water-soluble resin was 63 mass %, and the content of the graphite was 16 mass %. The results are shown in Table 1.

### Example 8

A fluorinated-rubber laminated metal sheet was produced to perform the bonding test in the same manner as in Example 6 except that adjustment was performed so that, in the surface-coating agent, the content of the silicone emulsion A was 10 mass %, the content of the water-soluble resin was 70 mass %, the content of the graphite was 18 mass %, and the content of the surfactant was 2 mass %. The results are shown in Table 1.

### Example 9

A fluorinated-rubber laminated metal sheet was produced to perform the bonding test in the same manner as in Example 2 except that a cellulose resin (trade name “METOLOSE® SM-100”, manufactured by Shin-Etsu Chemical Co., Ltd.) as a water-soluble resin and a nonionic surfactant (trade name “SURFLON S-386”, manufactured by AGC SEIMI CHEMICAL CO., LTD.) as a surfactant (surface-adjusting agent) were further added into the surface-coating agent to perform adjustment so that, in the surface-coating agent, the content of the silicone emulsion B was 90 mass %, a content of the water-soluble resin was 9 mass %, and a content of the surfactant was 1 mass %. The results are shown in Table 1.

### Example 10

A fluorinated-rubber laminated metal sheet was produced to perform the bonding test in the same manner as in Example 9 except that adjustment was performed so that, in the surface-coating agent, the content of the silicone emulsion B was 70 mass % and the content of the water-soluble resin was 29 mass %. The results are shown in Table 1.

### Example 11

A fluorinated-rubber laminated metal sheet was produced to perform the bonding test in the same manner as in Example 2 except that a cellulose resin (trade name “METOLOSE® SM-100”, manufactured by Shin-Etsu Chemical Co., Ltd.) as a water-soluble resin, graphite (trade name “AQ-E3571”, manufactured by RESINO COLOR INDUSTRY CO., LTD.), and a nonionic surfactant (trade name “SURFLON S-386”, manufactured by AGC SEIMI CHEMICAL CO., LTD.) as a surfactant (surface-adjusting agent) were further added into the surface-coating agent to perform adjustment so that, in the surface-coating agent, the content of the silicone emulsion B was 40 mass %, a content of the water-soluble resin was 47 mass %, a content of the graphite was 12 mass %, and a content of the surfactant was 1 mass %. The results are shown in Table 1.

### Example 12

A fluorinated-rubber laminated metal sheet was produced to perform the bonding test in the same manner as in Example 11 except that adjustment was performed so that, in the surface-coating agent, the content of the silicone emulsion B was 20 mass %, the content of the water-soluble resin was 63 mass %, and the content of the graphite was 16 mass %. The results are shown in Table 1.

### Example 13

A fluorinated-rubber laminated metal sheet was produced to perform the bonding test in the same manner as in Example 11 except that adjustment was performed so that, in the surface-coating agent, the content of the silicone emulsion B was 10 mass %, the content of the water-soluble resin was 67 mass %, the content of the graphite was 18 mass %, and the content of the surfactant was 5 mass %. The results are shown in Table 1.

### Example 14

A fluorinated-rubber laminated metal sheet was produced to perform the bonding test in the same manner as in Example 3 except that a cellulose resin (trade name “METOLOSE® SM-100”, manufactured by Shin-Etsu Chemical Co., Ltd.) as a water-soluble resin, graphite (trade name “AQ-E3571”, manufactured by RESINO COLOR INDUSTRY CO., LTD.), and a nonionic surfactant (trade name “SURFLON S-386”, manufactured by AGC SEIMI CHEMICAL CO., LTD.) as a surfactant (surface-adjusting agent) were further added into the surface-coating agent to perform adjustment so that, in the surface-coating agent, the content of the silicone emulsion C was 10 mass %, a content of the water-soluble resin was 70 mass %, a content of the graphite was 18 mass %, and a content of the surfactant was 2 mass %. The results are shown in Table 1.

### Example 15

A fluorinated-rubber laminated metal sheet was produced to perform the bonding test in the same manner as in Example 1 except that: a silicone emulsion D (trade name “?POLON-MF-33A”, manufactured by Shin-Etsu Chemical Co., Ltd.) was used instead of the silicone emulsion A; and a cellulose resin (trade name “METOLOSE® SM-100”, manufactured by Shin-Etsu Chemical Co., Ltd.) as a water-soluble resin, graphite (trade name “AQ-E3571”, manufactured by RESINO COLOR INDUSTRY CO., LTD.), and a nonionic surfactant (trade name “SURFLON S-386”, manufactured by AGC SEIMI CHEMICAL CO., LTD.) as a surfactant (surface-adjusting agent) were further added into the surface-coating agent to perform adjustment so that, in the surface-coating agent, a content of the silicone emulsion D was 40 mass %, a content of the water-soluble resin was 40 mass %, a content of the graphite was 12 mass %, and a content of the surfactant was 8 mass %. The results are shown in Table 1.

### Example 16

A fluorinated-rubber laminated metal sheet was produced to perform the bonding test in the same manner as in Example 15 except that adjustment was performed so that, in the surface-coating agent, the content of the silicone emulsion D was 20 mass %, the content of the water-soluble resin was 59 mass %, the content of the graphite was 16 mass %, and the content of the surfactant was 5 mass %. The results are shown in Table 1.

### Example 17

A fluorinated-rubber laminated metal sheet was produced to perform the bonding test in the same manner as in Example 1 except that: a silicone emulsion E (trade name “POLON-MF-56”, manufactured by Shin-Etsu Chemical Co., Ltd.) was used instead of the silicone emulsion A; and a cellulose resin (trade name “METOLOSE® SM-100”, manufactured by Shin-Etsu Chemical Co., Ltd.) as a water-soluble resin, graphite (trade name “AQ-E3571”, manufactured by RESINO COLOR INDUSTRY CO., LTD.), and a nonionic surfactant (trade name “SURFLON S-386”, manufactured by AGC SEIMI CHEMICAL CO., LTD.) as a surfactant (surface-adjusting agent) were further added into the surface-coating agent to perform adjustment so that, in the surface-coating agent, a content of the silicone emulsion E was 40 mass %, a content of the water-soluble resin was 40 mass %, a content of the graphite was 12 mass %, and a content of the surfactant was 8 mass %. The results are shown in Table 1.

### Example 18

A fluorinated-rubber laminated metal sheet was produced to perform the bonding test in the same manner as in Example 17 except that adjustment was performed so that, in the surface-coating agent, the content of the silicone emulsion E was 20 mass %, the content of the water-soluble resin was 59 mass %, the content of the graphite was 16 mass %, and the content of the surfactant was 5 mass %. The results are shown in Table 1.

### Example 19

A fluorinated-rubber laminated metal sheet was produced to perform the bonding test in the same manner as in Example 1 except that: a silicone emulsion F (trade name “ATW-008S”, manufactured by Taisei Fine Chemical Co., Ltd.) was used instead of the silicone emulsion A; and a cellulose resin (trade name “METOLOSE® SM-100”, manufactured by Shin-Etsu Chemical Co., Ltd.) as a water-soluble resin, graphite (trade name “AQ-E3571”, manufactured by RESINO COLOR INDUSTRY CO., LTD.), and a nonionic surfactant (trade name “SURFLON S-386”, manufactured by AGC SEIMI CHEMICAL CO., LTD.) as a surfactant (surface-adjusting agent) were further added into the surface-coating agent to perform adjustment so that, in the surface-coating agent, a content of the silicone emulsion F was 20 mass %, a content of the water-soluble resin was 54 mass %, a content of the graphite was 16 mass %, and a content of the surfactant was 10 mass %. The results are shown in Table 1.

### Example 20

A fluorinated-rubber laminated metal sheet was produced to perform the bonding test in the same manner as in Example 1 except that: a silicone emulsion G (trade name “CTW-113S”, manufactured by Taisei Fine Chemical Co., Ltd.) was used instead of the silicone emulsion A; and a cellulose resin (trade name “METOLOSE® SM-100”, manufactured by Shin-Etsu Chemical Co., Ltd.) as a water-soluble resin, graphite (trade name “AQ-E3571”, manufactured by RESINO COLOR INDUSTRY CO., LTD.), and a nonionic surfactant (trade name “SURFLON S-386”, manufactured by AGC SEIMI CHEMICAL CO., LTD.) as a surfactant (surface-adjusting agent) were further added into the surface-coating agent to perform adjustment so that, in the surface-coating agent, a content of the silicone emulsion G was 20 mass %, a content of the water-soluble resin was 54 mass %, a content of the graphite was 16 mass %, and a content of the surfactant was 10 mass %. The results are shown in Table 1.

### Comparative Example 1

A fluorinated-rubber laminated metal sheet was produced to perform the bonding test in the same manner as in Example 1 except that: the silicone emulsion A was not used; and a surface-coating agent containing 45 mass % of a cellulose resin (trade name “METOLOSE® SM-100”, manufactured by Shin-Etsu Chemical Co., Ltd.) as a water-soluble resin, 15 mass % of graphite (trade name “AQ-E3571”, manufactured by RESINO COLOR INDUSTRY CO., LTD.), 39 mass % of a synthesized wax (trade name “HYTEC E-6500”, manufactured by TOHO Chemical Industry Co., Ltd.), and 1 mass % of a nonionic surfactant (trade name “SURFLON S-386”, manufactured by AGC SEIMI CHEMICAL CO., LTD.) as a surfactant (surface-adjusting agent) was used. The results are shown in Table 1.

### Comparative Example 2

A fluorinated-rubber laminated metal sheet was produced to perform the bonding test in the same manner as in Example 1 except that: the silicone emulsion A was not used; and a surface-coating agent containing 79 mass % of a cellulose resin (trade name “METOLOSE® SM-100”, manufactured by Shin-Etsu Chemical Co., Ltd.) as a water-soluble resin, 20 mass % of graphite (trade name “AQ-E3571”, manufactured by RESINO COLOR INDUSTRY CO., LTD.), and 1 mass % of a nonionic surfactant (trade name “SURFLON S-386”, manufactured by AGC SEIMI CHEMICAL CO., LTD.) as a surfactant (surface-adjusting agent) was used. The results are shown in Table 1.

### Comparative Example 3

A fluorinated-rubber laminated metal sheet was produced to perform the bonding test in the same manner as in Example 6 except that adjustment was performed so that, in the surface-coating agent, the content of the silicone emulsion A was 5 mass %, the content of the water-soluble resin was 75 mass %, the content of the graphite was 18 mass %, and the content of the surfactant was 2 mass %. The results are shown in Table 1.

### Comparative Example 4

A fluorinated-rubber laminated metal sheet was produced to perform the bonding test in the same manner as in Example 11 except that adjustment was performed so that, in the surface-coating agent, the content of the silicone emulsion B was 2 mass %, the content of the water-soluble resin was 70 mass %, the content of the graphite was 18 mass %, and the content of the surfactant was 10 mass %. The results are shown in Table 1.

### Comparative Example 5

A fluorinated-rubber laminated metal sheet was produced to perform the bonding test in the same manner as in Example 14 except that adjustment was performed so that, in the surface-coating agent, the content of the silicone emulsion C was 8 mass %, the content of the water-soluble resin was 72 mass %, and the content of the graphite was 18 mass %. The results are shown in Table 1.

### Comparative Example 6

A fluorinated-rubber laminated metal sheet was produced to perform the bonding test in the same manner as in Example 15 except that adjustment was performed so that, in the surface-coating agent, the content of the silicone emulsion D was 8 mass %, the content of the water-soluble resin was 72 mass %, the content of the graphite was 15 mass %, and the content of the surfactant was 5 mass %. The results are shown in Table 1.

### Comparative Example 7

A fluorinated-rubber laminated metal sheet was produced to perform the bonding test in the same manner as in Example 17 except that adjustment was performed so that, in the surface-coating agent, the content of the silicone emulsion E was 8 mass %, the content of the water-soluble resin was 65 mass %, the content of the graphite was 17 mass %, and the content of the surfactant was 10 mass %. The results are shown in Table 1.

TABLE 1

| | Silicone emulsion | | Water-soluble | Graphite | Synthesized wax | Surfactant | Bonding force | Bloom amount |
|---|---|---|---|---|---|---|---|---|
| | Type | Content [mass %] | resin [mass %] | [mass %] | [mass %] | [mass %] | [MPa] | [mg/m²] |
| Example 1 | Silicone emulsion A | 100 | 0 | 0 | 0 | 0 | 0 | 200 |
| Example 2 | Silicone emulsion B | 100 | 0 | 0 | 0 | 0 | 0 | 200 |
| Example 3 | Silicone emulsion C | 100 | 0 | 0 | 0 | 0 | 0 | 200 |
| Example 4 | Silicone emulsion A | 90 | 9 | 0 | 0 | 1 | 0 | 180 |
| Example 5 | Silicone emulsion A | 70 | 29 | 0 | 0 | 1 | 0 | 140 |
| Example 6 | Silicone emulsion A | 40 | 47 | 12 | 0 | 1 | 0 | 80 |
| Example 7 | Silicone emulsion A | 20 | 63 | 16 | 0 | 1 | 2.1 | 40 |
| Example 8 | Silicone emulsion A | 10 | 70 | 18 | 0 | 2 | 5.6 | 20 |
| Example 9 | Silicone emulsion B | 90 | 9 | 0 | 0 | 1 | 0 | 180 |
| Example 10 | Silicone emulsion B | 70 | 29 | 0 | 0 | 1 | 0 | 140 |
| Example 11 | Silicone emulsion B | 40 | 47 | 12 | 0 | 1 | 0 | 80 |
| Example 12 | Silicone emulsion B | 20 | 63 | 16 | 0 | 1 | 0 | 40 |
| Example 13 | Silicone emulsion B | 10 | 67 | 18 | 0 | 5 | 3.0 | 20 |
| Example 14 | Silicone emulsion C | 10 | 70 | 18 | 0 | 2 | 8.7 | 20 |
| Example 15 | Silicone emulsion D | 40 | 40 | 12 | 0 | 8 | 7.1 | 80 |
| Example 16 | Silicone emulsion D | 20 | 59 | 16 | 0 | 5 | 8.2 | 40 |
| Example 17 | Silicone emulsion E | 40 | 40 | 12 | 0 | 8 | 3.2 | 80 |
| Example 18 | Silicone emulsion E | 20 | 59 | 16 | 0 | 5 | 5.2 | 40 |
| Example 19 | Silicone emulsion F | 20 | 54 | 16 | 0 | 10 | 4.0 | 40 |
| Example 20 | Silicone emulsion G | 20 | 54 | 16 | 0 | 10 | 4.8 | 40 |
| Comparative | — | 0 | 45 | 15 | 39 | 1 | 17.9 | 0 |
| Example 1 | | | | | | | | |
| Comparative | — | 0 | 79 | 20 | 0 | 1 | 15.3 | 0 |
| Example 2 | | | | | | | | |
| Comparative | Silicone emulsion A | 5 | 75 | 18 | 0 | 2 | 12.7 | 10 |
| Example 3 | | | | | | | | |
| Comparative | Silicone emulsion B | 2 | 70 | 18 | 0 | 10 | 11.6 | 4 |
| Example 4 | | | | | | | | |
| Comparative | Silicone emulsion C | 8 | 72 | 18 | 0 | 2 | 14.4 | 16 |
| Example 5 | | | | | | | | |
| Comparative | Silicone emulsion D | 8 | 72 | 15 | 0 | 5 | 14.8 | 16 |
| Example 6 | | | | | | | | |
| Comparative | Silicone emulsion E | 8 | 65 | 17 | 0 | 10 | 13.6 | 16 |
| Example 7 | | | | | | | | |

Each component in Table 1 is as follows.
Silicone emulsion A: amino-modified-type silicone emulsion (trade name “POLON-MF-14E”, manufactured by Shin-Etsu Chemical Co., Ltd.)
Silicone emulsion B: dimethyl-type silicone emulsion (trade name “POLON-MN-ST”, manufactured by Shin-Etsu Chemical Co., Ltd.)
Silicone emulsion C: epoxy-modified-type silicone emulsion (trade name “POLON-MF-18T”, manufactured by Shin-Etsu Chemical Co., Ltd.)
Silicone emulsion D: silicone emulsion for inorganic fiber (trade name “POLON-MF-33A”, manufactured by Shin-Etsu Chemical Co., Ltd.)
Silicone emulsion E: reactive-type silicone emulsion (trade name “POLON-MF-56”, manufactured by Shin-Etsu Chemical Co., Ltd.)
Silicone emulsion F: anionic siloxane-crosslinking-type acryl emulsion (trade name “ATW-008S”, manufactured by Taisei Fine Chemical Co., Ltd.)
Silicone emulsion G: cationic siloxane-crosslinking-type acryl emulsion (trade name “CTW-113S”, manufactured by Taisei Fine Chemical Co., Ltd.)
Water-soluble resin: cellulose resin (trade name “METOLOSE(R) SM-100”, manufactured by Shin-Etsu Chemical Co., Ltd.)
Graphite: trade name “AQ-E3571” (manufactured by RESINO COLOR INDUSTRY CO., LTD.)
Synthesized wax: trade name “HYTEC E-6500” (manufactured by TOHO Chemical Industry Co., Ltd.)
Surfactant: nonionic surfactant (trade name “SURFLON S-386”, manufactured by AGC SEIMI CHEMICAL CO., LTD.)

As found from Table 1, with the fluorinated-rubber-metal laminates produced in Examples 1 to 20, the surface-coating layer formed by applying and curing the surface-coating agent containing 10 mass % or more of the silicone emulsion is provided on the fluorinated rubber layer. In such a fluorinated-rubber-metal laminate, at least 20 mg/m² of bloom is precipitated on the surface of the surface-coating layer, and by the precipitated bloom, not only the fluorinated rubber layer is protected together with the surface-coating layer but also the fluorinated rubber layer and the housing material are separated. Therefore, the bonding force to the housing was remarkably reduced and the bonding to the housing material was able to be inhibited. Note that, an amount of the bloom that contributed to the reduction in the bonding force depended on only the amount of the silicone emulsion added, and almost no effect by the material of the silicone emulsion was observed.

Meanwhile, since the silicone emulsion was not contained in the surface-coating agent to be used when the surface-coating layer was formed, both the fluorinated-rubber-metal laminates produced in Comparative Examples 1 and 2 exhibited large values of the bonding force to the housing material. Since the content of the silicone emulsion contained in the surface-coating agent to be used was less than 10 mass % when the surface-coating layer was formed, each of the fluorinated-rubber-metal laminates produced in Comparative Examples 3 to 7 had a small effect of reducing the bonding force to the housing material, and exhibited large bonding force.

### INDUSTRIAL APPLICABILITY

As described above, since the bonding to the housing material can be inhibited under the use environment according to the fluorinated-rubber-metal laminate of the present disclosure, it can be particularly suitably used as a material for a gasket such as a gasket for a cylinder head and a gasket for a compressor.

1. A fluorinated-rubber-metal laminate comprising:
a metal sheet;
a fluorinated rubber layer laminated on one surface or both surfaces of the metal sheet; and
a surface-coating layer with which the fluorinated rubber layer is coated, wherein
the surface-coating layer is a cured film obtained by curing of a coating film of a surface-coating agent containing a silicone emulsion, and
the silicone emulsion is contained at 10 mass % or more in the surface-coating agent.

2. The fluorinated-rubber-metal laminate according to claim 1, wherein at least 20 mg/m² of bloom is precipitated on a surface of the surface-coating layer.

3. The fluorinated-rubber-metal laminate according to claim 1, wherein the silicone emulsion is selected from the group consisting of an amino-modified-type silicone emulsion, an epoxy-modified-type silicone emulsion, a dimethyl-type silicone emulsion, a reactive-type silicone emulsion, a silicone emulsion for an inorganic fiber, an anionic siloxane-crosslinking-type acryl emulsion, and a cationic siloxane-crosslinking-type acryl emulsion.

4. The fluorinated-rubber-metal laminate according to claim 1, wherein the metal sheet is a steel sheet.

5. The fluorinated-rubber-metal laminate according to claim 1, wherein a thickness of the surface-coating layer is 0.5 μm or more.

6. The fluorinated-rubber-metal laminate according to claim 1, wherein an adhesive is interposed between the metal sheet and the fluorinated rubber layer.

7. The fluorinated-rubber-metal laminate according to claim 1, wherein the fluorinated-rubber-metal laminate is a material for a gasket.
